(19) United States
(12) Patent Application Publication
(10) Pub. No.: US 2022/0345856 A1
(43) Pub. Date: Oct. 27, 2022

(54) METHOD FOR DATA TRANSFER IN A V2X NETWORK

(71) Applicant: Robert Bosch GmbH, Stuttgart (DE)

(72) Inventors: Tobias Frye, Braunschweig (DE); Frank Hofmann, Hildesheim (DE); Kurt Eckert, Ditzingen (DE)

(21) Appl. No.: 17/659,118

(22) Filed: Apr. 13, 2022

(30) Foreign Application Priority Data
Apr. 22, 2021 (DE) 10 2021 204 016.0

(51) Int. Cl. H04W 4/12; H04W 12/06; H04W 4/40; H04W 28/06

(52) U.S. Cl. CPC H04W 4/12; H04W 12/06; H04W 4/40; H04W 28/06

(57) ABSTRACT

A method for data transfer in a V2X communication network (V2X: vehicle-to-everything). A communication control module for an at least semi-automated vehicle is further provided, which is designed to carry out the method for data transfer. The data transfer in the V2X communication network takes place with the aid of V2X messages, which are coded by a sender and decoded by at least one receiver. A V2X message includes in each case a piece of context information about surroundings of the sender and/or of the receiver with respect to a vehicle and/or to an object and/or to a person. The piece of context information 505 is utilized for each V2X message for validation of the V2X message and/or for reduction of a packet size of the V2X message.

### CROSS REFERENCE

The present application claims the benefit under 35 U.S.C. § 119 of German Patent Application No. DE 10 2021 204 016.0 filed on Apr. 22, 2021, which is expressly incorporated herein by reference in its entirety.

### FIELD

The present invention relates to a method for data transfer in a V2X network as well as to a communication control module for carrying out the method. The present invention further relates to a vehicle system, in which the communication control module is used.

### BACKGROUND INFORMATION

A method for data transfer in a V2V network (V2V: vehicle-to-vehicle), in which pieces of context information are transferred prior to the actual V2V communication between the vehicles for validation and authentication of the vehicles, is described in China Patent Application No. CN 107040506A.

### SUMMARY

An object of the present invention is to improve a method for data transfer in a V2X communication network. The object of the present invention is further to specify an improved communication control module for carrying out the method and to provide an optimized vehicle system.

This object may be achieved in accordance with the present invention. Further advantageous specific embodiments of the present invention are disclosed herein.

According to the present invention, a method is provided for data transfer in a V2X communication network (V2X: vehicle-to-everything). In accordance with an example embodiment of the present invention, data transfer in the V2X communication network takes place with the aid of V2X messages, which are coded by a sender and decoded by at least one receiver. A V2X message includes in each case a piece of context information about surroundings of the sender and/or of the receiver with respect to a vehicle which, in addition to a motor vehicle may, for example, also be an eBike or an alternative vehicle, and/or an object and/or a person. The context information is utilized for each V2X message for the reduction of a packet size of the V2X message and/or for the validation of the V2X message.

With the aid of the use of the piece of context information for a V2X communication, it is advantageously possible to enhance the safety of the V2X communication network, in that each V2X message may be verified based on the piece of context information. V2X messages with a negative validation may, in particular, be detected early and, if necessary, be downgraded as less trustworthy or may be completely eliminated. In this way potential damage to the vehicle control or to the vehicle system may be prevented, if the at least one receiver is designed as a vehicle. Moreover, a receiver may exchange V2X messages independently of the sender and is advantageously not reliant on establishing a trustworthy connection with the sender prior to the actual communication. This saves time and reduces the effort, since no complicated verification process prior to the actual V2X communication is required. The communication between the communication partners may take place instantaneously.

In addition, it is possible to advantageously carry out for each message both a validation of the message, i.e., a check of the content of the message by the at least one receiver for logical inconsistency, as well as a reduction of the packet size of the V2X message by the sender based on the piece of context information. At the same time, the sender may carry out a reduction of the packet size of the V2X message without the at least one receiver carrying out a validation of the message. With the aid of a reduced packet size, the message exchange may be more efficiently designed and the frequency bands (frequency spectrum) available for the message transfer may be better utilized. Sender and receiver in this case are not limited to vehicles; rather, an object, for example, an infrastructure object, may also be designed as a sender. Conventional methods from the related art may be used for the coding and decoding.

In one further specific embodiment of the present invention, the packet size of the V2X message is reduced by the sender in that the sender applies a processing rule on the basis of the piece of context information, which includes a correlation between a data size and a value to be conveyed. To reduce the packet size of the V2X message, the sender may utilize a processing rule, which may be implemented easily and with little effort. In order to ascertain the data size in the bit unit for the value of a data field to be conveyed, the mathematical correlation

data size=log₂ (value to be conveyed)

is advantageously utilized as the processing rule with the logarithm for base 2. In this case, the processing rule may be utilized for all data fields of the V2X message to be conveyed, for which not the entire value range, but a specific value from the value range is intended to be conveyed. In this way, it is possible to reduce the packet size by approximately 25% compared to a message having a full packet size, in which in each case the entire value ranges of the data fields are transferred or in which, instead of the entire value ranges, an additional data field, in which the lengths of the individual data fields are contained, is also transferred. The specific embodiment provided may be advantageously used by the sender if it is known to the sender which piece of context information is known to the receiver.

In one further specific embodiment of the present invention, the sender conveys at least one V2X message with full packet size to the at least one receiver. The sender conveys further V2X messages with reduced packet size, in that the sender applies on the basis of the piece of context information the processing rule, which includes the correlation between the data size and the value to be conveyed. The sender may carry out once or occasionally periodically repeat the conveyance of the V2X message with full packet size and, after the conveyance of the V2X message with full packet size or between the periodic conveyance of the V2X message with full packet size, may convey further V2X messages with reduced packet size. The packet size in this case may be reduced with the aid of the aforementioned processing rule.

This provided specific embodiment of the present invention is suitable, in particular, advantageously, if the sender does not know which piece of context information is known to the at least one receiver. For example, because the receiver generates the piece of context information based on internal and external sensors and not based on an evaluation of a first data field of a received V2X message, which has been conveyed by the sender. In this case, the field of view of the receiver via the sensors may be unknown to the sender. In that case, it is advantageously sufficient if the sender conveys a V2X message with full packet size (and thus with complete context information) only once to the receiver, and then further V2X messages with reduced packet size. In this way, the data traffic is not unnecessarily increased.

In addition, the provided specific embodiment of the present invention is advantageously suitable if multiple receivers are present and the sender does not know which receiver has been newly added. In this case, the sender may occasionally periodically repeat the transmission of the V2X message with full packet size and between the periodic repetition again convey V2X messages with reduced packet size. Thus, the data traffic is not unnecessarily increased and the sender may exchange V2X messages regardless of the number of receivers and is advantageously not reliant on establishing a trustworthy connection with each individual receiver prior to the actual communication. The communication may be initiated instantaneously, even in the case of newly added receivers. Thus, the provided V2X communication allows for the greatest possible flexibility with respect to the number of communication users.

In one further specific embodiment of the present invention, the decoding takes place during the receipt of the V2X message. The at least one receiver carries out a validation of the V2X message in parallel to the decoding on the basis of the piece of context information, which includes a check of a content of the V2X message for logical inconsistency. An instruction for processing or rejecting the V2X message is generated based on the check of the content of the V2X message and the instruction for the V2X message is implemented.

It is advantageously unnecessary for the V2X message to be initially fully received and decoded and subsequently subjected to verification based on the piece of context information; rather, this may take place in parallel and already during the receipt of the message. Thus, time may be saved and an instruction to process or to reject the V2X message may be more rapidly generated. Thus, the provided method may contribute to time savings and preservation of resources. The check for logical inconsistency in this case may include utilizing various data fields of the V2X message in terms of a cross-validation. For example, in a length field containing a CAM message (CAM: Cooperative Awareness Message), in which a vehicle length is included and a vehicle type field, in which the type of vehicle is conveyed. If the vehicle type field includes the value for a passenger car and the value of the length field corresponds, for example, to that of a truck, the receiver determines that a logical inconsistency in the message is present, since the evaluated information is unable to be unambiguously assigned either to a passenger car or unambiguously to a truck. The message may then be marked or classified as non-trustworthy or may be directly rejected in order to protect the vehicle system, in particular, the vehicle control, from an unauthorized access based on the content of the V2X message to be processed.

In one further specific embodiment of the present invention, a sensor unit and/or a stored map and/or a V2X message history and/or an Internet download is utilized by the sender and/or by the at least one receiver for generating the piece of context information.

Various options, which may be used individually or in combination with one another, are available for generating the piece of context information. This may therefore provide the greatest possible flexibility and improve the reliability and safety of the communication and of the vehicle system. The sensor unit in this case may include internal sensors, which are integrated into the vehicle and/or into the infrastructure object, as well as external sensors.

In one alternative embodiment of the present invention, it is possible to generate the piece of context information by a received separate context message.

In one further specific embodiment of the present invention, a first data field of the V2X message is evaluated by the at least one receiver for generating the piece of context information. Based on the evaluation of the first data field, the instruction for processing or rejecting the V2X message is generated. Various options, which may be used individually or in combination with one another, are available for generating the piece of context information. This may therefore provide the greatest possible flexibility and improve the reliability and safety of the communication and of the vehicle system. This provided specific embodiment is advantageously particularly suitable in combination with the reduction of the packet size of the V2X message by the sender. The sender may thus provide the required piece of context information to the receiver and, at the same time, limit it to the essential pieces of information required by the receiver for processing.

In one further specific embodiment of the present invention, a V2X message corresponds to a CAM message (CAM: Cooperative Awareness Message), to a CPM message (CPM: Collective Perception Message), or to another V2X message. Another V2X message in this case may correspond to an existing V2X message or to a future V2X message, for example, to a VAM message (VAM: Vulnerable Road User Awareness Message), to a DENM message (DENM: Decentralized Environmental Notification Messages), or to a BSM message (America), (BSM: Basic Safety Message). In this way, conventional V2X message formats may be utilized that include a defined message structure. This simplifies the implementation and ensures a stable, reliable communication.

In one further specific embodiment of the present invention, the sender and/or the receiver is/are designed as a vehicle.

The provided method is advantageously not limited to the sender and the receiver both being designed as a vehicle and thus exchanging V2V messages. The method may be used advantageously and without restrictions for senders and receivers of various designs, for example, infrastructure object (sender) and vehicle (receiver) or person (sender) and vehicle (receiver), or vehicle (sender) and person (receiver), etc.

According to an example embodiment of the present invention, a communication control module for an at least semi-automated vehicle is provided, which is designed to carry out the provided method for data transfer. With the aid of the communication control module, a reliable hardware is provided, which is able to carry out the provided method. In the process, the communication control module is able to assume the function of a firewall and block undesirable messages. The communication control module is designed, in particular, to carry out the validation of the V2X message and to generate the instruction for processing or rejecting the V2X message, and to directly implement this instruction in each case. Alternatively, the communication control module may also be designed as a combined hardware and software module or in one further alternative embodiment as a software module. At the same time, the communication control module may include a vehicle control module integrated therein, which carries out the actual control of the vehicle and, accordingly includes the vehicle control software. In addition, it is also possible to use a separate vehicle control module, which is connected to the communication control module via a hardwired communication system, so that the communication control module assumes the communication functions, i.e., the decoding and validation of the V2X message and the generation of the instruction and rejects the V2X message in the event of a negative validation or forwards it with downgraded significance to the vehicle control module or, in the event of a positive validation, forwards the V2X message to the vehicle control module for processing. The hardwired communication system may, for example, be designed as a bus system (as a CAN bus, etc.) or as an automotive Ethernet.

In one alternative embodiment of the present invention, the communication control module may be designed to generate the instruction for processing or rejecting the V2X message and to directly implement the instruction for rejecting the V2X message for lack of validation of the message (lack of plausibility). The instruction for processing the V2X message may be forwarded by the communication control module to a vehicle control module, which is communicatively linked to the communication control module, for example, via a field bus.

According to an example embodiment of the present invention, a vehicle system is further provided. The vehicle system includes an at least semi-automated vehicle. The at least semi-automated vehicle includes a receiver device for receiving a V2X message and the provided communication control module for carrying out the provided method.

With the aid of the communication control module, a reliable hardware is provided, which is able to carry out the provided method. Alternatively, the communication control module may also be designed as a combined hardware and software module or in one further alternative embodiment as a software module. The communication control module in this case may assume the function of a firewall and block undesirable messages. At the same time, the communication control module includes the vehicle control module integrated therein, which carries out the actual control of the vehicle and, accordingly, includes the vehicle control software. In addition, it is also possible to use a separate vehicle control module, which is communicatively linked to the communication control module via a hardwired communication system, so that the communication control module assumes the communication functions: the decoding and validation of the V2X message and the generation of the instructions and the rejection of the V2X message in the event of a negative validation or the forwarding of the V2X message with downgraded significance to the vehicle control module or the forwarding to the vehicle control module for processing in the event of a positive validation of the V2X message. The receiver device may correspond to an antenna or to an alternative means for receiving V2X messages. The hardwired communication system may, for example, be designed as a bus system (as a CAN bus, etc.) or as an automotive Ethernet.

The advantageous designs and refinements of the present invention explained above and/or disclosed may be used individually or else also in arbitrary combination with one another.

### BRIEF DESCRIPTION OF THE DRAWINGS

The properties, features, and advantages of the present invention described above, as well as the manner in which these are achieved become more clearly and readily understandable in conjunction with the following description of exemplary embodiments, which are explained in greater detail in conjunction with the figures.

FIG. 1 schematically shows a representation of a flowchart for a provided method for data transfer according to a first specific embodiment of the present invention.

FIG. 2 schematically shows a representation of a first specific embodiment of a provided vehicle system, in accordance with the present invention.

FIG. 3 schematically shows a representation of a second specific embodiment of a provided vehicle system, in accordance with the present invention.

FIG. 4 schematically shows a flowchart for a provided method for data transfer according to one second specific embodiment in a vehicle system according to FIGS. 2 and 3, in accordance with the present invention.

FIG. 5 schematically shows a representation of a flowchart for a provided method for data transfer according to one third specific embodiment, in accordance with the present invention.

FIG. 6 schematically shows a representation of a V2X message with a packet size according to the related art.

FIG. 7 schematically shows representations of one first and one second V2X message each with a reduced packet size according to the method for data transfer according to FIG. 5.

### DETAILED DESCRIPTION OF EXAMPLE EMBODIMENTS

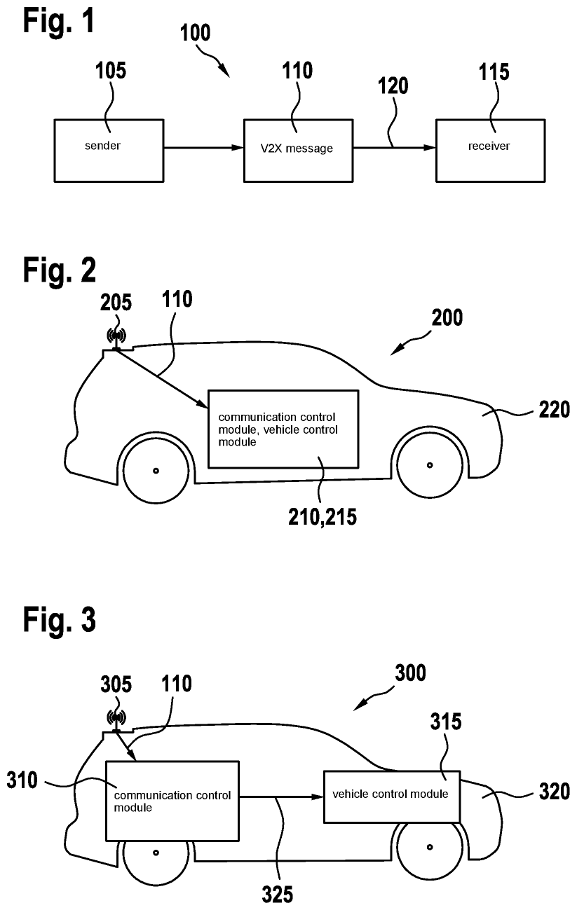

FIG. 1 schematically shows a representation of a flowchart for a provided method for data transfer according to one first specific embodiment 100. The method for data transfer 100 may be used in a V2X communication network (V2X: vehicle-to-everything) and includes a sender 105 and at least one receiver 115. In the example shown in FIG. 1, the communication network includes by way of example only one receiver 115. It may, however, include multiple receivers, which may also be subsequently added and may be designed according to the following description. Sender 105 may be a vehicle, an infrastructure object (for example, a traffic light, a mobile construction site, a road bollard or traffic bollard, etc.) an object (for example, a tunnel, a bridge, etc.) or a person. Receiver 115 may be designed as a vehicle, so that a vehicle-to-vehicle (V2V: vehicle-to-vehicle) communication is possible if sender 105 is also designed as a vehicle. Alternatively, receiver 115 may also be designed as an infrastructure object, so that a vehicle-to-infrastructure (V2I: vehicle-to-infrastructure) communication is possible, if sender 105 is designed as a vehicle. In addition, receiver 115 may also be designed as a person, so that a vehicle-to-person (V2P: vehicle-to-pedestrian) communication is possible if sender 105 is designed as a vehicle. In addition, further designs of senders 105 and receivers 115 are possible.

Sender 105 generates and codes a V2X message 110 before it conveys message 110 via a transmission channel 120 to receiver 115. Transmission channel 120 may, for example, be designed as a radio channel, for example, as a 4G-LTE network or as a 5G network, in order to form a wireless radio link between the aforementioned users. Receiver 115 decodes V2X message 110 and evaluates its content. Coding and decoding may take place according to conventional methods and are accordingly not explicitly explained. This will, in particular, not be further discussed below. If, for example, sender 105 and receiver 115 are each designed as vehicles, then V2X message 110 may correspond to a CAM message (CAM: Cooperative Awareness Message) or to a CPM message (CPM: Collective Perception Message). Other existing or future V2X message formats are possible such as, for example, a VAM message (VAM: Vulnerable Road User Awareness Message), a DENM message (DENM: Decentralized Environmental Notification Messages), or a BSM message (America), (BSM: Basic Safety Message).

V2X message 110 may include a piece of context information about surroundings of sender 105 and/or of receiver 115 with respect to a vehicle and/or to an object and/or to a person. For example, the piece of context information may include data regarding a further distanced vehicle such as, for example, vehicle type, vehicle speed, vehicle length, acceleration, mass, position, etc. These pieces of context information may have been received by sender 105, for example, with the aid of a CPM message from a vehicle driving directly ahead of sender 105, if the further distanced vehicle is situated in the field of view of an internal sensor of the vehicle driving directly ahead of sender 105 and the internal sensor is able to detect the further distanced vehicle. In addition, the piece of context information may include data regarding the vehicle driving directly ahead of sender 105, for example, vehicle type, vehicle speed, vehicle length, acceleration, mass, position, etc. These pieces of context information may have been received by sender 105, for example, with the aid of a CAM message from the vehicle driving directly ahead of sender 105. This example has, however, been selected only as exemplary and may also be used otherwise in an alternative embodiment, for example, by forming the piece of context information from a received CPM message or from a received CAM message.

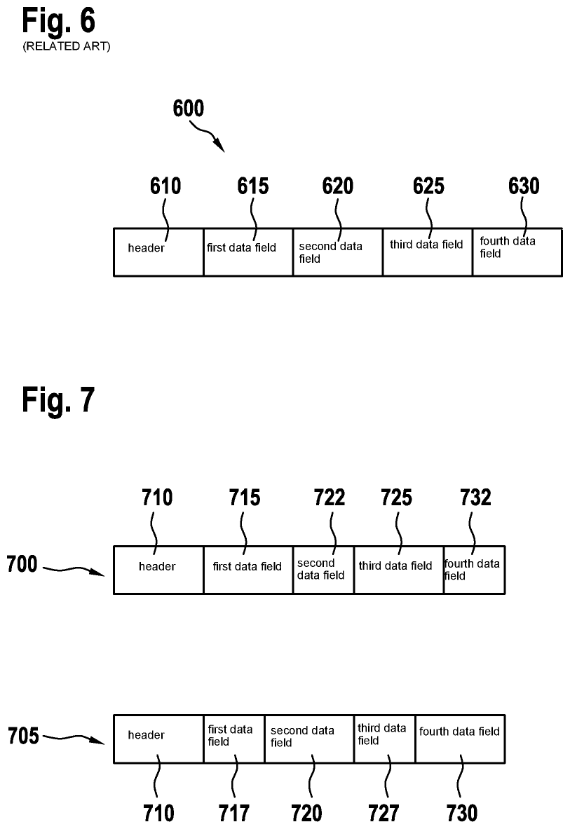

Further alternatives for generating the piece of context information are explained in even greater detail below with reference to FIG. 5. The design or structure of a CAM message is explained in greater detail with reference to FIGS. 6 and 7. Based on the piece of context information, it is possible for each V2X message to reduce a validation of the V2X message and/or a packet size of the V2X message. Specifically, as a function of whether a V2V communication, V2I communication or V2P communication is present. Method 100 is advantageously implementable regardless of the platform.

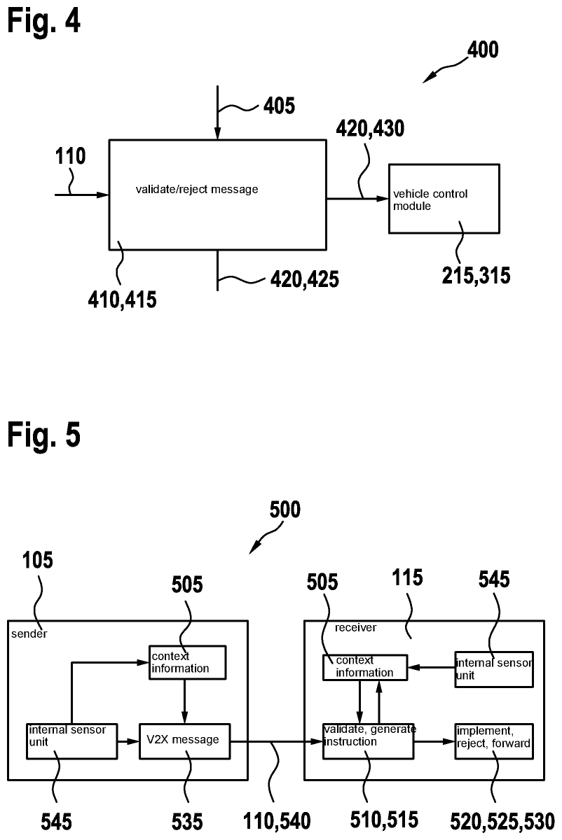

FIG. 2 schematically shows a representation of one first specific embodiment of a provided vehicle system 200. For example, vehicle system 200 corresponds to receiver 115 shown in FIG. 1. Vehicle system 200 includes an at least semi-automated vehicle 220. Vehicle 220 includes a receiver device 205. Receiver device 205 is designed preferably as an antenna, in order to receive the V2X message, i.e., in the present case for example, a CAM message or a CPM message, which has been conveyed by sender 105 via transmission channel 120 in FIG. 1. Vehicle system 200 further includes a communication control module 210, which is designed to carry out method 100 in FIG. 1, as well as methods 400, 500 described below in FIGS. 4 and 5. Communication control module 210 may be designed, in particular, in the form of a hardware and may carry out the validation of the V2X message based on the piece of context information, i.e., may assume communication functions. Alternatively, communication control module 210 may also be designed as a combined hardware and software module. In this case, it is possible that communication control module 210 includes a vehicle control module 215, which includes the vehicle control software and assumes the actual control function of vehicle 220 based on received and to be processed V2X message 110.

FIG. 3 schematically shows a representation of one second specific embodiment of a provided vehicle system 300. Vehicle system 300 is designed similarly to vehicle system 200 in FIG. 2, i.e., including an at least semi-automated vehicle 320, which includes a receiver device 305. The latter is designed again as an antenna in the example shown. In contrast to vehicle system 200 in FIG. 2, vehicle system 300 in FIG. 3 includes a separate communication control module 310 as well as a separate vehicle control module 315, which are connected to one another via a hardwired communication system 325. Communication control module 310 may be designed similarly to communication control module 210, i.e., it is able to carry out method 100 in FIG. 1, as well as methods 400, 500 described below in FIGS. 4 and 5. Communication control module 310 may, in particular, be designed in the form of a hardware and may carry out the validation of the V2X message based on the piece of context information, i.e., may assume communication functions. Based on the validation of the V2X message by communication control module 310, a V2X message may be categorized as trustworthy and may be forwarded to vehicle control module 315 for processing or for further processing via hardwired communication system 325, implemented, for example, as a CAN bus or automotive Ethernet. Vehicle control module 315 may carry out the control of vehicle 320 based on the processed or further processed V2X message.

FIG. 4 schematically shows a representation of a flowchart for a provided method for data transfer according to one second specific embodiment 400 in a vehicle system 200, 300 according to FIGS. 2 and 3. Thus, FIG. 4 shows vehicle system 200, 300 in FIGS. 2 and 3 as receiver 115 of a V2X message 110. The V2X message is decoded, for example, by communication control module 210, 310 during the receipt of the V2X message 110 and V2X message 110 is validated 410 in parallel to the decoding on the basis of a piece of context information 405. For example, context information 405 may be generated by a sensor unit and/or via an evaluation of a first data field of the V2X message from receiver 115. Further options for generating the piece of context information are explained with reference to FIG. 5. These may also be used in FIG. 4 and in the preceding figures.

Based on the evaluation of the first data field, which may, for example, be a speed field or a vehicle type field, etc., communication control module 210, 310 may generate an instruction for processing or rejecting the V2X message. If the speed field, for example, includes the value for a speed of a passenger car, which is formed greater than the value for the speed of a truck, and the vehicle type field includes the value for a truck, then communication control module 210, 310 may generate the instruction for rejecting 415 V2X message 110, since the content of the V2X message is not plausible, i.e. is logically inconsistent. Communication control module 210, 310 may accordingly reject 425 message 110, i.e., may implement 420 the instruction. Alternatively, communication module 210, 310 may characterize message 110 as less trustworthy, for example, by setting a value or a so-called “flag” and still forward message 110 to vehicle control module 310 for processing or for further processing in communication control module 210.

If, on the other hand, the speed field includes the speed of a passenger car and the vehicle field type includes the value for a passenger car, then communication control module 210, 310 may generate 415 the instruction for processing message 110 and may implement 420 this instruction, since the content of message 110 is plausible, i.e., is logically consistent. If communication control module 210 includes vehicle control module 215, then the processing of V2X message 110 may directly take place. Otherwise, communication control module 310 forwards 430 message 110 to vehicle control module 315 for processing.

In one further example, piece of context information 405 may, for example, include in the vehicle type field the value for a passenger car and in the vehicle length field as well as in a vehicle mass field the length and the weight of a truck. In one further alternative example, the vehicle type field may include the value for a truck and in a vehicle acceleration field the value for a passenger car, for example, the value for a sports car. The aforementioned examples are further possible cross-validation options for the validation of the individual data fields or data types of V2X message 110. These cross-validation data or values (logically inconsistent) may, for example, indicate an error (safety) at sender 105 or originator or a possible attacker (security), similar to the example previously cited above. Even in the two particular examples cited here, message 110 may be rejected by communication control module 210, 310. Otherwise, message 110 may represent a danger to the vehicle system (vehicle control module 215, 315) or to the function in the vehicle (for example, Highway Pilot Handsfree). This applies equally to the aforementioned example, in which message 110 is rejected due to logical inconsistency.

In one alternative example for a logical inconsistency, which may be determined based on piece of context information 405, the infrastructure as sender 105 may transmit a piece of object information about a pedestrian with position x (relative to sender 105) as piece of context information 405 to a receiver 115. A vehicle as sender 105 may transmit a CAM message with the same position x (relative to sender 105) as piece of context information 405 to the same receiver 115. Based on the validation of the two messages based on piece of context information 405, receiver 115 may ascertain, for example, that one of the two messages is with false or inaccurate information if the relative positions of the infrastructure and of the sending vehicle differ.

In one further alternative example for a logical inconsistency, which may be determined based on piece of context information 405, a vehicle as sender 105 may, for example, specify a value in the vehicle speed field of 200 km/h for the vehicle speed as piece of context information 405 in the message to a receiver 115. Receiver 115 may, for example, ascertain based on stored map data, which receiver 115 utilizes for generating piece of context information 405 and which specify the road topology or the road conditions, that the road topology does not allow for this speed at all, for example, because the road is a speed-30-zone or a sharp curve is present, etc. These two alternative examples as well are those in which the messages are to be rejected in each case after completed validation.

FIG. 5 schematically shows a representation of a flowchart for a provided method for data transfer according to one third specific embodiment 500. In this case a V2V communication is explained by way of example. It may alternatively, however, also take place in the form of a V2I or V2P communication, as explained above. Sender 105, a first vehicle, includes, for example, an internal sensor unit 545. Internal sensor unit 545 may, for example, include a camera, a radar, a LIDAR system, etc. Internal sensor unit 545 may detect the surroundings of sender 105, for example, preceding vehicles (motor vehicle, eBikes, etc.) and/or infrastructure objects and/or persons and/or obstacles, such as uneven roadway surfaces, undesirable objects on the roadway, etc. All of these pieces of information may be used for generating a V2X message 535, 110, i.e., in the present case a V2V message, for example, a CAM message or a CPM message, as piece of context information 505. In addition to the data, which may be registered by internal sensor unit 545, piece of context information 505 may further retain data from an external sensor unit. In addition, a stored map and/or an Internet download by sender 105 may also be utilized for forming piece of context information 505. A V2X message history for various points in time may also be possibly used for generating piece of context information 505. For example, the piece of context information may contain tire fragments of a vehicle at a distance x (relative to sender 105, in addition, for example, a low degree of confidence having been specified due to poor visibility conditions).

In contrast to method 400 in FIG. 4, sender 105 may reduce the packet size of V2X message 110, in that sender 105 applies based on piece of context information 505 a processing rule, which includes a correlation between a data size and a value to be conveyed. The processing rule corresponds to the following mathematical correlation, in order to ascertain the data size (i), for example, 6 bit, ii), for example, 5 bit) in the bit unit for the value (i) to be conveyed, for example, 5 m length, ii) for example 3000 kg weight) of a data field (here i), for example, of the vehicle length field and ii) of the vehicle mass field of a passenger car:

data size=log₂ (value to be conveyed)

in this case, log₂ corresponds to the logarithm for base 2. The processing rule may be utilized for all data fields of the V2X message to be conveyed, for which not the entire value range, but only one specific value from the value range is to be conveyed. For the sake of simplicity, however, only two examples thereof are cited. With the aid of this approach, the packet size (the entire length) of message 110 may be advantageously reduced, and may be used by sender 105, in particular, in those cases, in which it is known to sender 105 which piece of context information 505 is known to receiver 115.

Alternatively, sender 105 may convey at least one V2X message 110 with full packet size to the at least one receiver 115. In this case, piece of context information 505 may have been received as explained above. Sender 105 subsequently conveys further V2X messages 110 with reduced packet size, in that the sender applies on the basis of piece of context information 505 the aforementioned processing rule, which includes the correlation between the data size and the value to be conveyed. Thus, if sender 105 does not know, for example, that it is known to receiver 115 that the vehicle driving ahead of sender 105 is a passenger car, because, for example, no CPM message has been conveyed to receiver 115, the sender 105 is then able to convey not only the required 6 bit for representing the length of the passenger car, but the full value range (also from other data fields of message 110). The sender may occasionally periodically repeat the conveyance of the V2X message with full packet size and, between the conveyances of the V2X message with full packet size, convey further V2X messages with reduced packet size, as described. If multiple receivers are present, for example, and the sender does not know which receiver has been newly added, the sender may then convey the full value range, i.e., the V2X message with full packet size.

Sender 105 conveys message 110 with reduced packet size 540 to receiver 115. Receiver 115 decodes message 110 during the receipt and carries out in parallel thereto a validation by 510 based on piece of context information 505. Reference is made to the above explanation to FIG. 4 for details regarding the validation. Piece of context information 505, which was generated by internal sensor unit 545 of receiver 115, may, in particular, be used for the decoding. For example, sensor unit 545 of the receiver may have suddenly detected an undesirable object resting on the roadway (for which a high degree of confidence has been indicated, for example), for example, tire fragments of a vehicle at a distance y (relative to receiver 115). Together with piece of context information 505 read in from message 110, i.e., for example, via evaluation of the first data field of message 110 by sender 105, which includes, for example, the vehicle length or the vehicle speed or the vehicle type, etc., receiver 115 is able to generate 515 the instruction, which is implemented by communication control module 210, 310. Since distances x and y for the tire fragments do not correspond to one another, for example, and the degree of confidence of the measured value is low for distance x, but high for distance y, a logical inconsistency may therefore be present, so that generated instruction 515 includes a rejection of message 110. This instruction is implemented by communication control module 210, 310 and the message is rejected 525.

Alternatively, if the two distances x and y coincide, then generated instruction 515 may include a processing or forwarding for processing. This is implemented 520 and message 110 is forwarded 530, for example, to vehicle control module 315. Alternatively, distances x and y may each specify distances to vehicles or to persons, etc. The example explained is merely exemplary in nature and the present invention is not limited thereto.

In addition, a value range of internal sensor unit 545 of sender 105 may also be limited if receiver 115 utilizes not only received pieces of context information 505 of message 110, but also the properties detected with internal sensor unit 545 of receiver 115. If sender 105 (vehicle 1) travels next to receiver (vehicle 2) in the same direction, then the value range of sender 105 may be severely limited, since in that case only the angle must then be specified in detail, without the rough orientation in addition.

FIG. 6 schematically shows a representation of a V2X message with a packet size according to the related art. For example, the V2X message in this case corresponds to a CAM message, so that FIG. 6 represents a structure 600 of a conventional CAM message. The CAM message includes a header 610, a first data field 615, a second data field 620, a third data field 625 and a fourth data field 630. For example, first data field 615 is designed as a vehicle speed field, second data field 620 is designed as a vehicle length field, third data field 625 is designed as a vehicle acceleration field and fourth data field 630 is designed as a vehicle mass field. The following table (Tab1) shows a detail from the CAM message in FIG. 6 including the full data sizes of the individual data fields.

TABLE 1

| | | Full data |
|---|---|---|
| Data field | Value range | size |
| Vehicle type | Unknown(0), | 8 Bit |
| (StationType) | pedestrian(1), . . . , | |
| | passengerCar(5), | |
| | bus(6), | |
| | lightTruck(7), | |
| | heavyTruck(8) | |
| Vehicle speed (Speed) | 0 m/s to 163.83 | 14 Bit |
| | m/s (589.8 km/h) | |
| VehicleLength | 0.1 to 102.3 m | 10 Bit |
| Vehicle acceleration | −16.0 m/s² to | 9 Bit |
| (LongitudinalAcceleration) | 16.0 m/s² | |
| VehicleMass | 100 kg to 102400 | 10 Bit |
| | kg | |

The full packet size of the CAM message with structure 600 is thus made up of the full data sizes of the individual data fields, since all data are transferred with the maximum value range. If a minimum possible data size is to be set for the individual data fields, then the data size for each data field must be known at sender 105 and at receiver 115. This results in the individual data fields in the message with structure 600 invariably having the maximum data size. An automatic detection of the minimum possible data size for each data field would namely only be possible if the data size of the fields were transferred with the message, which does not occur.

The structure of a CPM message is designed similarly to a CAM message. This is not shown in FIG. 6, however. A CPM message, like a CAM message, has a header (ITS PDU Header). The CPM message further includes a first data field (StationData), a second data field (CPMManagement), a third data field (SensorInformation) and a fourth data field (PerceivedObjects). In contrast to the data fields of a CAM message, the second, third and fourth data fields may include message control data (CPMManagement), sensor data (SensorInformation) and data regarding the perceived objects (PerceivedObjects). The CPM messages cited above in the application may include the illustrated structure.

FIG. 7 schematically shows a representation of a first and of a second V2X message, each with reduced packet size according to the method for data transfer according to FIG. 5. The first and second V2X message each corresponds, for example, to CAM messages. The structure of a CAM message according to one first specific embodiment 700 provides that the provided CAM message also includes a header 710. In addition, the CAM message with structure 700 includes a first data field 715, a second data field 722, a third data field 725 and a fourth data field 732. First data field 715 is designed as a vehicle speed field and includes, for example, the data size of first data field 615 of the message with conventional structure 600. According to Tab1, i.e., 14 bit. In FIG. 7, the vehicle type field is not shown in Tab1, this is only for reasons of clarity. However, the CAM messages with structures 700, 705 in FIG. 7 may each include the vehicle type field. Second data field 722 is designed as a vehicle length field and, due to method 500 carried out by sender 105, includes, for example, only a portion of the data size of second data field 620 of the message with structure 600, i.e., in the present case according to Tab1, for example, only 6 bit. For example, for the reason that the vehicle corresponds to a passenger car and the vehicle length is accordingly shorter than the vehicle length of a truck. Third data field 725 is designed as a vehicle acceleration field and includes a data size identical to third data field 625, for example, 9 bit according to Tab1. Fourth data field 732 is designed as a vehicle mass field and may be only half as large as fourth data field 630 in FIG. 6 due to the fact that the vehicle corresponds to a passenger car, thus, for example, may include only 5 bit according to Tab1.

The structure of CAM message 705 differs, for example, from structure 700 in that first data field 717 has a data size, which is designed only half as large as the data size of first data field 715, thus, for example, only 7 bit according to Tab1 (instead of 14 bit). For example, for the reason that the vehicle is a truck and the vehicle speed of the truck is reduced compared to the vehicle speed of the passenger car with message structure 700. In contrast, the vehicle length field as second data field 720 is designed in terms of size as large as second data field 620 in FIG. 6, i.e., it includes a data size of 10 bit according to Tab1. By contrast, third data field 727 is designed only approximately two-thirds as large as third data field 725 of the CAM message of the passenger car, i.e., for example, 6 bit (instead of 9 bit) according to Tab1. Fourth data field 730 on the other hand is designed only approximately twice as large as fourth data field 732 of the message with structure 700, in the present case, for example, 10 bit as in Tab1. Thus, the messages with structures 700, 705 each have a reduced packet size compared to the message in FIG. 6 with structure 600, i.e., a total length of the message by approximately 25% less than the message in FIG. 6. This may be achieved without additionally added data fields for the minimum possible data size to be set for the individual data fields, specifically by utilizing the piece of context information as explained.

The present invention has been described in detail with the aid of preferred exemplary embodiments. Instead of the described exemplary embodiments, further exemplary embodiments are possible, which may include further modifications or combinations of described features. For this reason, the present invention is not limited by the described examples, since other variations may be derived therefrom by those skilled in the art without departing from the scope of protection of the present invention.

What is claimed is:

1. A method for data transfer in a V2X (vehicle-to-everything) communication network, comprising:
transferring data in the V2X communication network using V2X messages, which are coded by a sender and decoded by at least one receiver, each of the V2X messages including in each case a piece of context information about surroundings of the sender and/or of the at least one receiver, with respect to a vehicle and/or to an object and/or to a person; and
using the piece of context information for each V2X message of the V2X messages for reduction of a packet size of the V2X message and/or for validation of the V2X message.

2. The method as recited in claim 1, wherein the packet size of the V2X message is reduced by the sender, in that the sender applies, based on the piece of context information, a processing rule which includes a correlation between a data size and a value to be conveyed.

3. The method as recited in claim 2, wherein the sender conveys at least one V2X message with full packet size to the at least one receiver, and the sender conveys further V2X messages with reduced packet size, in that the sender applies, based on the piece of context information, the processing rule which includes the correlation between the data size and the value to be conveyed.

4. The method as recited in claim 1, wherein the decoding takes place during the receipt of the V2X message, the at least one receiver carrying out based on the piece of context information a validation of the V2X message in parallel to the decoding, which includes a check of a content of the V2X message for logical inconsistency, an instruction for processing or rejecting the V2X message being generated based on the check of the content of the V2X message, and the instruction for the V2X message being implemented.

5. The method as recited in claim 1, wherein a sensor unit and/or a stored map and/or a V2X message history and/or an Internet download, is used by the sender and/or by the at least one receiver for generating the piece of context information.

6. The method as recited in claim 4, wherein a first data field of the V2X message is evaluated by the at least one receiver for generating the piece of context information, and the instruction for processing or rejecting the V2X message being generated based on the evaluation of the first data field.

7. The message as recited in claim 1, wherein a V2X message corresponds to a CAM (Cooperative Awareness Message) message, to a CPM (Collective Perception Message) message, or to another V2X message.

8. The method as recited in claim 1, wherein the sender and/or the at least one receiver (115) is a vehicle.

9. A communication control module for an at least semi-automated vehicle, the communication control module being configured for data transfer in a V2X (vehicle-to-everything) communication network, the communication control module configured to:
transfer data in the V2X communication network using V2X messages, which are coded by a sender and decoded by at least one receiver, each of the V2X messages including in each case a piece of context information about surroundings of the sender and/or of the at least one receiver, with respect to a vehicle and/or to an object and/or to a person; and
use the piece of context information for each V2X message of the V2X messages for reduction of a packet size of the V2X message and/or for validation of the V2X message.

10. A vehicle system, comprising:
an at least semi-automated vehicle, the at least semi-automated vehicle including a receiving device configured to receive a V2X message and a communication control module, the communication control module being configured for data transfer in a V2X (vehicle-to-everything) communication network, the communication control module configured to:
transfer data in the V2X communication network using V2X messages, which are coded by a sender and decoded by at least one receiver, each of the V2X messages including in each case a piece of context information about surroundings of the sender and/or of the at least one receiver, with respect to a vehicle and/or to an object and/or to a person; and
use the piece of context information for each V2X message of the V2X messages for reduction of a packet size of the V2X message and/or for validation of the V2X message.
